(19) United States
(12) Patent Application Publication
(10) Pub. No.: US 2023/0140555 A1
(43) Pub. Date: May 4, 2023

(54) TRANSPARENT NETWORK SERVICE CHAINING

(71) Applicant: Microsoft Technology Licensing, LLC, Redmond, WA (US)

(72) Inventors: Geoffrey Hugh OUTHRED, Seattle, WA (US); Anavi Arun NAHAR, Seattle, WA (US); Shuo DONG, Yarrow Point, WA (US); Xun FAN, Newcastle, WA (US); Matthew Heeuk YANG, Lynnwood, WA (US); Plaban MOHANTY, Bellevue, WA (US); Jinzhou JIANG, Redmond, WA (US); Yifeng HUANG, Bellevue, WA (US); Nicole Antonette KISTER, Redmond, WA (US); Shekhar AGARWAL, Bellevue, WA (US); Yanan SUN, Bellevue, WA (US); Caleb Lee-Yen WYLLIE, Silverdale, WA (US)

(21) Appl. No.: 17/677,742

(22) Filed: Feb. 22, 2022

Related U.S. Application Data
(60) Provisional application No. 63/274,379, filed on Nov. 1, 2021.

(51) Int. Cl. G06F 9/455; H04L 12/66; H04L 12/46; H04L 67/10

(52) U.S. Cl. CPC G06F 9/45558; H04L 12/66; H04L 12/4641; H04L 67/10; G06F 2009/4557; G06F 2009/45595; H04L 2212/00

(57) ABSTRACT

The present disclosure relates to systems, methods, and computer-readable media for facilitating the transparent insertion of network virtual appliances into a cloud computing system. For example, a transparent network virtual appliance system can dynamically, seamlessly, and quickly add one or more network virtual appliances utilizing a chained gateway load balancer. In particular, the transparent network virtual appliance system can provide additional services to an application virtual network within a cloud computing system without disrupting or modifying the existing architecture of the cloud computing system.

### CROSS-REFERENCE TO RELATED APPLICATIONS

This application claims the benefit of and priority to U.S. Provisional Application No. 63/274,379 filed Nov. 1, 2021, the entirety of which is incorporated herein by reference.

### BACKGROUND

Recent years have seen significant advancements in hardware and software platforms that implement cloud computing systems. Cloud computing systems often make use of different types of virtual services (e.g., computing containers, virtual machines) that provide remote storage and computing functionality to various clients or customers. These virtual services can be hosted by respective server nodes on a cloud computing system.

Despite advances in the area of cloud computing, current cloud computing systems face several technical shortcomings that result in inaccurate, inefficient, and inflexible operations, particularly in the areas of network service chaining and network virtual appliances. For context, a service chain can refer to a series of traffic processing services that are linked together. For instance, a service chain provides a mechanism for acting on network traffic flows to and from services running in cloud computing infrastructures or systems. Additionally, a network virtual appliance (or simply NVA) can refer to a computing service traditionally implemented in hardware in an enterprise network that has been moved to run inside a virtual machine in a cloud computing infrastructure or system. In many implementations, network traffic and data coming into a given cloud computing system flows through a network virtual appliance.

As just mentioned, current cloud computing systems that implement network virtual appliances face several technical shortcomings that result in inefficient, inaccurate, and inflexible operations. For instance, many current systems inefficiently insert network virtual appliances into a network path of a cloud computing system. When inserting a network virtual appliance into the traffic flow of a current cloud computing infrastructure, many current systems require significant changes to the architecture and operation of the cloud computing infrastructure as well as reconfiguring functions of the network virtual appliance functions. These problems are often compounded as additional network virtual appliances are inserted into a cloud computing system.

To illustrate, many current systems require user-defined network architecture changes and manual address reconfigurations to include a network virtual appliance into a current network traffic flow. This often results in inaccuracies due to the complexities of properly rerouting traffic flows and creating traffic flow rules. For example, in many instances, inserting network virtual appliances into a cloud computing system alters the data path as the source address of the cloud computing system needs to be modified so that connections can be terminated at the network virtual appliance. Further, these modifications reduce the diagnosability of network failures, which leads to an increase in support volume and system downtime when problems arise. In addition, changes to Domain Name System (DNS) records to direct data to newly added network virtual appliances can be slow (e.g., hours to days) and result in nonfunctioning systems while waiting for DNSs to update.

In addition, current systems are inefficient. For example, many current systems suffer from a high risk of failure due to bottlenecking and having a single point of failure in their network. Indeed, in addition to the limited and fixed throughput in these current systems, if the network virtual appliance fails, there is no other path for the network traffic and all of the backend applications in the cloud computing system become unavailable, causing an outage for the cloud computing system. Further, due to the complexities and issues mentioned above, inserting a network virtual appliance into current systems is often computationally expensive. For instance, modifications to a network virtual appliance in current systems commonly require updating network devices across the subnetworks of the cloud computing system.

Moreover, existing systems are often rigid and inflexible. For instance, many current systems insert network virtual appliances in a manner that intercepts all incoming traffic but ignores outgoing data. In other instances, current systems involve complex configurations that intercept both incoming and outgoing traffic. However, in these instances, current systems apply the same treatments to data regardless of its source or destination, which often necessitates very different treatments.

Furthermore, many current systems use network virtual appliances that are directly coupled with backend services, which can cause several issues. For example, a network virtual appliance bound to a backend service in a cloud computing system cannot be shared with other cloud computing systems. Further, network virtual appliances lumped with backend services commonly require management by the same team having expertise in managing a backend service despite often providing very different types of features and services that are unfamiliar to the team. Additionally, a coupled network virtual appliance is often limited to current offerings of features and services, which often is inadequate and not tailored to the particular needs of the cloud computing system.

These and other problems exist with regard to moving storage volumes between virtual boundaries on a cloud computing system.

### BRIEF SUMMARY

Embodiments of the present disclosure provide benefits and/or solve one or more of the foregoing or other problems in the art with systems, non-transitory computer-readable media, and methods that facilitate the transparent insertion of network virtual appliances into a cloud computing system. For example, the disclosed systems can dynamically, seamlessly, and quickly add one or more network virtual appliances to a cloud computing system without disrupting or modifying the existing architecture of the cloud computing system. Indeed, the disclosed systems can flexibly and efficiently add one or more network virtual appliances in a manner that overcomes the problems noted above.

To illustrate, in one or more implementations, the disclosed systems identify unprocessed data packets at a public load balancer of a cloud computing system that is configured to provide the data packets from an internet source to one or more virtual machines (e.g., backend services) of the cloud computing system (or vice versa). In one or more embodiments described herein, the disclosed systems can intercept unprocessed data packets from a public load balancer and provide them to a gateway load balancer via an encapsulation tunnel. In addition, the disclosed systems can provide the encapsulated data packets from the gateway load balancer to one or more network virtual appliances before transmitting the processed data packets back to the public load balancer via the external encapsulation tunnel. Further, the disclosed systems can send the processed data packets from the public load balancer to the one or more virtual machines (or to an internet source if the data packets originated from a virtual machine).

Additional features and advantages of one or more embodiments of the present disclosure are outlined in the following description.

### BRIEF DESCRIPTION OF THE DRAWINGS

The detailed description provides one or more embodiments with additional specificity and detail through the use of the accompanying drawings, as briefly described below.

FIG. 1 illustrates a diagram of a computing system environment including a cloud computing system and a transparent network virtual appliance system in accordance with one or more implementations.

FIG. 2 illustrates an overview diagram of transparently inserting network virtual appliances into a cloud computing system to process both incoming and outgoing network traffic in accordance with one or more implementations.

FIG. 3 illustrates an example of a cloud computing system having multiple customer virtual networks operating in connection with a transparently inserted set of network virtual appliances in accordance with one or more implementations.

FIGS. 4A-4B illustrate examples of network traffic flowing through a cloud computing system having a transparently inserted network virtual appliance in accordance with one or more implementations.

FIGS. 5A-5B illustrate examples of network traffic flowing through a cloud computing system having a chain of multiple network virtual appliances in accordance with one or more implementations.

FIGS. 6A-6B illustrate examples of network traffic flowing through a cloud computing system having an instance-level public IP and a network virtual appliance in accordance with one or more implementations.

FIGS. 7A-7B illustrate examples of network traffic from multiple customer virtual networks flowing through a shared network virtual appliance in accordance with one or more implementations.

FIG. 8 illustrates an example of various types of network virtual appliances in accordance with one or more implementations.

FIG. 9 illustrates an example of intranet traffic flowing through a cloud computing system having transparently inserted network virtual appliances in accordance with one or more implementations.

FIG. 10 illustrates an example series of acts for processing incoming data packets utilizing a transparently inserted network virtual appliance in accordance with one or more implementations.

FIG. 11 illustrates an example series of acts for processing outgoing data packets utilizing a transparently inserted network virtual appliance in accordance with one or more implementations.

FIG. 12 illustrates certain components that may be included within a computer system.

### DETAILED DESCRIPTION

The present disclosure generally relates to service chaining in a cloud computing system and more specifically to transparently inserting one or more network virtual appliances (NVAs) into a cloud computing system to process incoming and outgoing network traffic. For example, in one or more implementations, a transparent network virtual appliance system (or simply “transparent appliance system”) utilizes a gateway load balancer to intercept network traffic and redirect it to transparently inserted NVAs for processing in a manner that is dynamic, quick, and seamless. Indeed, the transparent appliance system can add NVAs to a cloud computing system in a manner that does not require routing tables updates, reconfigurations, or changes to the operation of the cloud computing system. Further, the transparent appliance system can provide separate paths that allow separate processing for incoming and outgoing network traffic, as further provided below.

To illustrate, in various implementations, with regards to incoming network data, the transparent appliance system can identify unprocessed data packets at a public load balancer of a cloud computing system that would normally provide the data packets to one or more virtual machines (e.g., backend services) of the cloud computing system. For instance, the transparent appliance system can intercept the unprocessed data packets from the public load balancer and provide them to a gateway load balancer via an external encapsulation tunnel. In addition, the transparent appliance system can provide the encapsulated data packets from the gateway load balancer to an NVA and transmit the processed data packets to the public load balancer via the same external encapsulation tunnel. Further, the disclosed systems can send the processed data packets from the public load balancer to the one or more virtual machines.

Regarding outgoing network data from a virtual machine of the cloud computing system, the transparent appliance system can identify data packets at the public load balancer that are addressed to an external computing device. In one or more implementations, the transparent appliance system redirects the data packets from the public load balancer to a gateway load balancer via an internal encapsulation tunnel and provides the encapsulated data packets from the gateway load balancer to an NVA. In addition, the transparent appliance system can transmit the processed data packets to the gateway load balancer via the internal encapsulation tunnel and send the processed data packets from the gateway load balancer to the external computing device.

As discussed in further detail below, the present disclosure includes several practical applications having features and functionality described herein that provide benefits and/or solve problems associated with service chaining within a cloud computing system. Some example benefits are discussed herein in connection with various features and functionality provided by the transparent appliance system (i.e., the transparent network virtual appliance system). Nevertheless, benefits explicitly discussed in connection with one or more implementations are provided by way of example and are not intended to be a comprehensive list of all possible benefits of the transparent appliance system.

To elaborate, in various implementations, the transparent appliance system adds one or more NVAs into a cloud computing system that includes a public load balancer and one or more virtual machines (VMs) on the backend of the cloud computing system. For instance, the public load balancer can receive incoming network traffic and provide it to the VMs. By implementing a gateway load balancer connected to NVAs, the transparent appliance system provides protection, features, and other services without disrupting the network traffic of data packets between the public load balancer and the VMs of the cloud computing system.

In various implementations, the transparent appliance system includes a gateway load balancer that intercepts data packets at the public load balancer and securely provides them to an NVA for processing before returning the processed data packets back to the public load balancer by way of the gateway load balancer and a secure encapsulation tunnel. By intercepting the data packets at a public load balancer by way of the gateway load balancer, the transparent appliance system greatly improves the simplicity and scalability with which NVAs can be added to a cloud computing system. For example, unlike current systems that often require manual reconfiguration of routing tables and DNS records, the transparent appliance system enables NVAs to be quickly added and implemented with minimal user interaction.

Additionally, the transparent appliance system facilitates the addition of multiple NVAs or sets of NVAs to improve the efficiency and accuracy of the cloud computing system. For example, the transparent appliance system flexibly enables the gateway load balancer to direct data packets to multiple sets NVAs without reconfiguring the cloud computing system each time an NVA is added, removed, or updated.

In various implementations, NVAs are maintained separately from other components of a cloud computing system. In this manner, the transparent appliance system can update and/or reconfigure the NVAs without pausing the VMs of the cloud computing system. Additionally, by maintaining NVAs that are separate from the other components of the cloud computing system, the transportation request enables NVAs to be tailored and specialized towards the needs of the cloud computing system, which can improve the efficiency and accuracy of the cloud computing system. Indeed, in various implementations, the NVAs and the VMs can exist in independent network spaces (virtual networks/subscriptions) as well as independent operational domains.

Further, because the NVAs are decoupled from the cloud computing system, the transparent appliance system can utilize the NVAs with multiple cloud computing systems at the same time, which greatly improves efficiency and reduces overprovisioning over conventional systems. In addition, by providing NVAs separate from VMs and/or other backend services, the transparent appliance system enables the NVAs to easily scale up or down to accommodate the needs of a cloud computing system, which accommodates spikes in demand and reduces overprovisioning. For instance, the transparent appliance system can eliminate the single-point-of-failure problem by utilizing multiple NVAs in a set and/or easily and quickly redirecting data packets to healthy NVAs when one or more NVAs become unhealthy.

As another example, in various implementations, the transparent appliance system utilizes different encapsulation tunnels for incoming and outgoing data packets. By utilizing an external encapsulation tunnel that redirects data packets originating outside of the cloud computing system as well as an internal encapsulation tunnel for data packets originating within the cloud computing system, the transportation request can improve process data packets with improved efficiency and flexibility. For instance, the transparent appliance system can utilize the same NVAs to apply different processing techniques to data packets based on the encapsulation tunnel from which they arrive. Indeed, by utilizing different encapsulation tunnels, the transparent appliance system can easily provide tailored operations to data packets to data packets arriving from different sources, including when different customers (e.g., operators of backend applications) share the same set of NVAs.

Features and functionality of the transparent appliance system may further enhance the processing of data packets without disruption to current cloud computing systems. For example, the transparent appliance system enables adding multiple sets of NVAs and/or multiple types of NVAs in a service chain of a cloud computing system. Examples of different types of NVAs include NVAs that serve as a firewall, cache, packet duplicator, threat detector, or deep packet inspector. Indeed, the transparent appliance system facilitates enhancing a cloud computing system by dynamically adding, removing, or updating various sets of NVAs from the cloud computing system (without disrupting data packet traffic flow between a public load balancer and a backend virtual machine). The transparent appliance system also facilitates NVAs to drop, terminate, or initiate communications, as further provided below.

As illustrated by the above discussion, the present disclosure utilizes a variety of terms to describe the features and advantages of the transparent appliance system (i.e., transparent network virtual appliance system). Additional detail is now provided regarding the meanings of some of these terms. For instance, as used herein, a “cloud computing system” refers to a network of connected computing devices that provide various services to computing devices (e.g., client devices, server devices, provider devices, customer devices, etc.). For instance, as mentioned above, a distributed computing system can include a collection of physical server devices (e.g., server nodes) organized in a hierarchical structure including clusters, computing zones, virtual local area networks (VLANs), racks, fault domains, etc. In various implementations, the network is a virtual network or a network having a combination of virtual and real components.

As used herein, a “virtual network” refers to a domain or grouping of nodes and/or services of a cloud computing system. Examples of virtual networks may include cloud-based virtual networks (e.g., VNets), subcomponents of a VNet (e.g., IP addresses or ranges of IP addresses), or other domain defining elements that may be used to establish a logical boundary between devices and/or data objects on respective devices. In one or more embodiments described herein, a virtual network may include host systems having nodes from the same rack of server devices, different racks of server devices, and/or different datacenters of server devices. Indeed, a virtual network may include any number of nodes and services associated with a control plane having a collection or database of mapping data maintained thereon. In one or more embodiments described herein, a virtual network may include nodes and services exclusive to a specific region of datacenters.

The term “virtual machine” (or VM) as used herein refers to a virtualization or emulation of a computer system. In various implementations, a VM provides the functions of a physical computer. VMs can range from a system-based VM, which emulates a full system or machine, to a process-based VM, which emulates computing programs, features, and services. In one or more implementations, one or more VMs are implemented as part of a VNet and/or on one or more server devices.

As used herein, the term “network virtual appliance” (or NVA) refers to a software appliance or computing service that is traditionally implemented in hardware in an enterprise network and/or that has been moved to run inside a virtual machine in a cloud computing infrastructure or system. An NVA can be implemented by one or more VMs and/or VNets. Additionally, an NVA can be deployed within a VNet and can include virtual machine scale sets (or VMSS). Examples of NVAs include, but are not limited to firewalls, caches, packet duplicators, threat detectors, and deep packet inspectors.

The term “load balancer,” as used herein refers to a network component that balances network traffic across two or more other network components. In various implementations, a load balancer facilitates session balancing across multiple network sessions. A load balancer can include a public load balancer, a gateway load balancer, or a management load balancer. For example, a public load balancer can receive and balance outbound internet traffic to VMs that reside inside a cloud computing system. In some implementations, a public load balancer has a public internet protocol (IP) address that is accessible with the internet and translates data packets received via a public IP address to a private IP address of a VM within the cloud computing system. A gateway load balancer can include a private load balancer located within a cloud computing system that largely redirects data packets to various components within the cloud computing system. A management load balancer can redirect data packets between an administrator device and VMs and/or NVAs, as described below.

As used herein, the term “customer” refers to an entity that provides one or more network applications to user devices. A customer is commonly an operator of a backend application and can be associated with a virtual network (or VNet) and/or a subscription service (e.g., a customer subscription that includes one or more customer VNets). For example, a first customer is associated with a first customer VNet offering a first set of VM applications (e.g., image search database) and a second customer is associated with a second customer VNet offering a second set of applications (e.g., email services). In general, each customer is associated with at least one public IP address where user devices can go to access applications offered by the customer.

In addition, as used herein, the term “provider” refers to an entity that provides one or more network appliances to customers or users. A provider can be associated with a virtual network (or VNet) and/or a subscription service (e.g., a provider subscription that includes one or more provider VNets). For example, a provider associated with a provider VNet offers one or more sets of NVAs to customers to protect, modify, filter, copy, inspect, or otherwise process data packets sent or received by the customer.

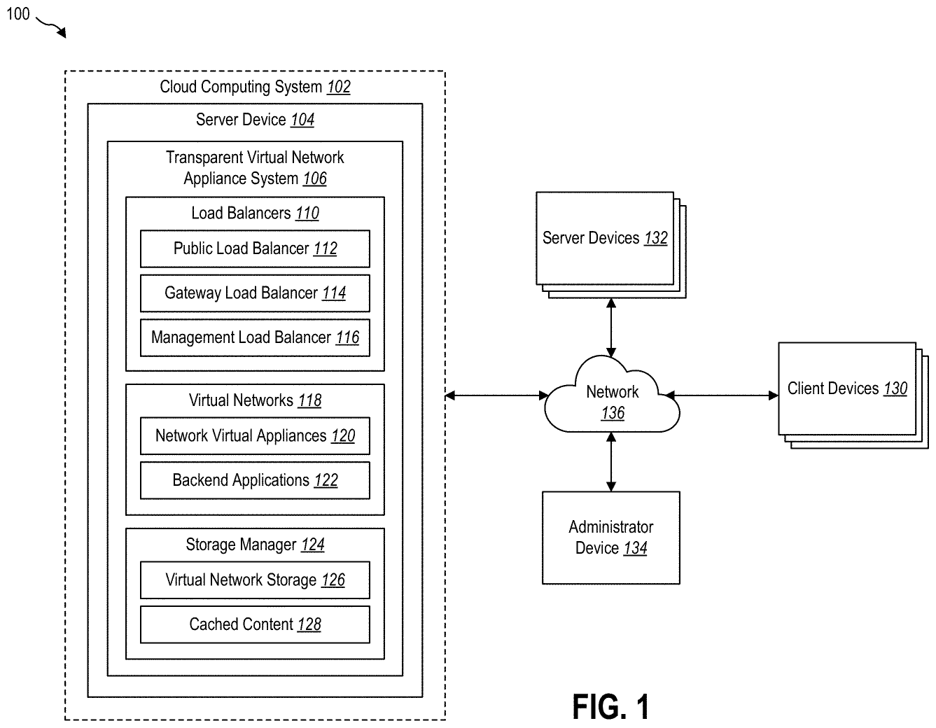

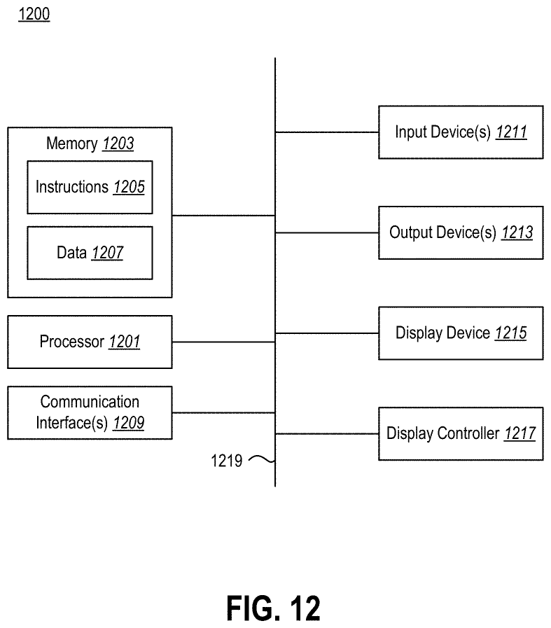

Additional detail regarding the transparent appliance system is now provided with reference to the figures portraying example implementations. For example, FIG. 1 illustrates a schematic diagram of a digital medium system environment 100 (or simply “environment 100”) for implementing a cloud computing system 102. The cloud computing system 102 can include any number of devices, such as a server device 104 that implements a transparent network virtual appliance system 106 (or simply “transparent appliance system 106”). In addition, the environment 100 includes client devices 130, server devices 132, and an administrator device 134 connected via a network 136. Additional detail regarding these computing devices and networks is provided below in connection with FIG. 12.

As shown, the environment 100 includes the client devices 130 and the server devices 132. In various implementations, the client devices 130 includes network or internet devices that send data packets to the transparent appliance system 106, such as requesting data or services from the transparent appliance system 106. Additionally, in one or more implementations, the server devices 132 include network or internet devices that provide services or data to one or more components of the transparent appliance system 106. For example, a network virtual appliance or a virtual machine on the transparent appliance system 106 sends out a software update request or a response to a received request to one of the server devices 132. In some implementations, one of the client devices 130 and one of the server devices 132 can be the same device.

As mentioned above, the transparent appliance system 106 is implemented on a server device 104. In various implementations, the server device 104 represents multiple server devices. In some implementations, the server device 104 hosts one or more virtual networks on which the transparent appliance system 106 is implemented.

As further shown, the transparent appliance system 106 can include various components, such as load balancers 110, virtual networks 118, and a storage manager 124. In one or more implementations, one or more of the components are physical. In some implementations, one or more of the components are virtual. Additionally, in example implementations, one or more of the components are located on a separate device from other components of the transparent appliance system 106. For instance, one or more of the load balancers 110 are located separately from the virtual networks 118 and/or storage manager 124.

FIG. 1 shows the load balancers 110, which may include a public load balancer 112, a gateway load balancer 114, and a management load balancer 116, each of which is introduced above. In various implementations, the public load balancer 112 receives data packets from the client devices 130 for the transparent appliance system 106 and/or provides data packets to the server devices 132. In some implementations, the gateway load balancer 114 intercepts incoming and/or outgoing data packets for processing by one or more NVAs of the transparent appliance system 106. In certain implementations, the management load balancer 116 facilitates communications with the administrator device 134, as further described below.

In one or more implementations, the virtual networks 118 include network virtual appliances 120 (or “NVAs 120”) and backend applications 122. For instance, the NVAs 120 can include a set of multiple NVAs providing the same (e.g., duplicative) functions. In some instances, the NVAs 120 include different NVA types, such as a firewall NVA, a packet duplication NVA, and a web cache NVA. In example implementations, the NVAs 120 are part of one or more virtual networks 118 offered by a provider that is building or offering data packet processing services. Accordingly, in particular implementations, the NVAs 120 are associated with a provider entity or provider subscription.

In various implementations, the transparent appliance system 106 deploys the NVAs 120 in a VNet of a provider (e.g., a provider's VNet). In one or more implementations, one or more of the NVAs 120 have (a) a shared physical network interface card (NIC) for external/internal interfacing with the cloud computing system 102, (b) separate physical NICs for external/internal interfacing, or (c) separate sets of NICs for different cloud computing system each having with different frontend IP addresses.

In various implementations, the transparent appliance system 106 provides unprocessed data packets (e.g., data packets that are unfiltered, uncopied, uninspected, etc.) to the NVAs 120. In particular, the gateway load balancer 114 intercepts data packets from the public load balancer 112 and provides them to the NVAs 120 for processing. In some implementations, the data packets are provided within one or more encapsulations tunnels. Additionally, in many instances, the gateway load balancer 114 provides the processed data packets back to the 112, which continues to reroute the data packets as originally intended (e.g., to the public load balancer 112, the client devices 130, or the server devices 132).

In some implementations, the backend applications 122 (e.g., VMs) provide various services and features. For example, one or more of the backend applications 122 include a hosted website or email client. In one or more implementations, the backend applications 122 are part of a virtual network that is separate from a virtual network that hosts the NVAs 120. For example, one or more backend applications 122 are hosted by a customer entity and/or customer subscription.

In various implementations, the transparent appliance system 106 includes the storage manager 124. For example, the storage manager 124 stores and/or retrieves various data corresponding to the transparent appliance system 106. As shown, the storage manager 124 includes virtual network storage 126 and cached content 128. In some implementations, virtual network storage 126 includes instructions, configurations, rules, data packets, software, updates, etc., for either the NVAs 120 and/or the backend applications 122.

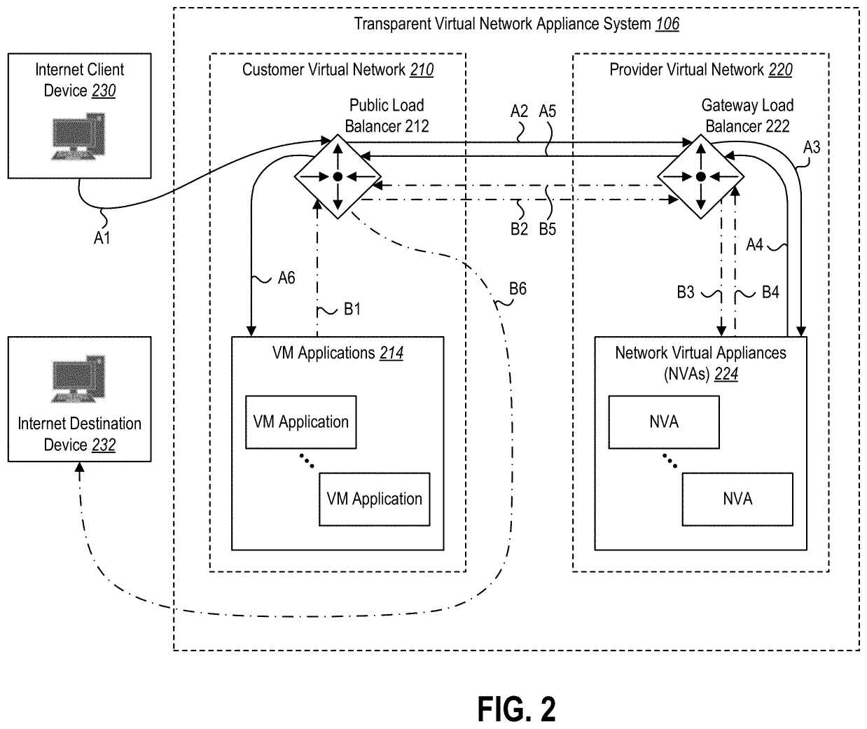

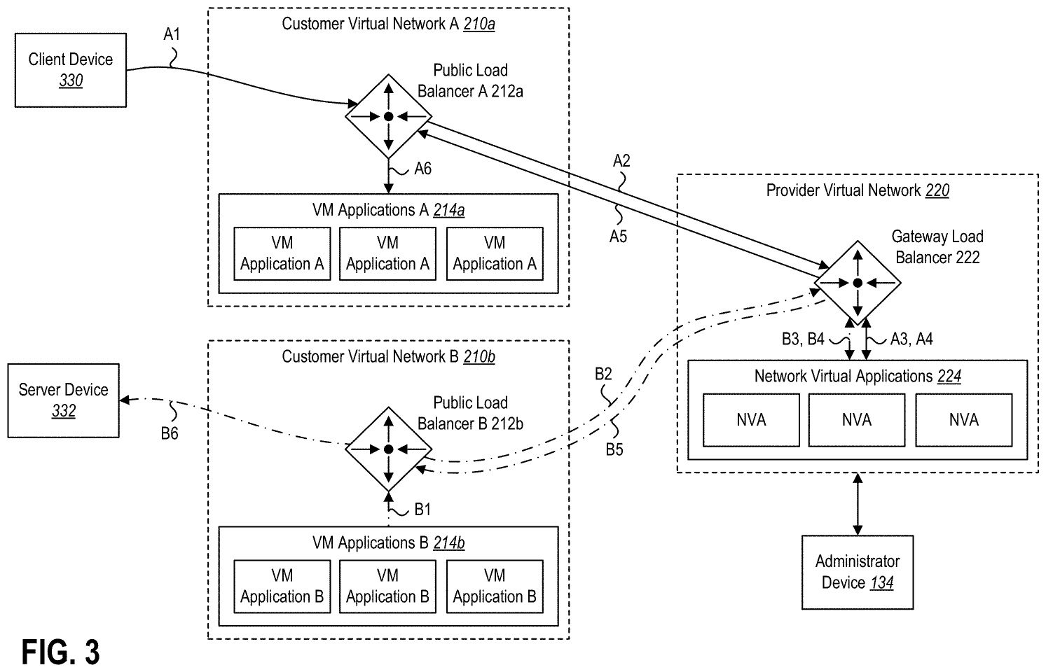

An overview of the transparent appliance system 106 described herein will now be provided in connection with FIGS. 2 and 3. To illustrate, FIG. 2 provides an overview diagram of transparently inserting network virtual appliances into a cloud computing system to process both incoming and outgoing network traffic in accordance with one or more implementations.

As shown, FIG. 2 includes an implementation of the transparent network virtual appliance system 106 (or simply “transparent appliance system 106”), an internet client device 230, and an internet destination device 232. In various implementations, the internet client device 230 and the internet destination device 232 can represent the client devices 130 and the server devices 132 introduced above in connection with FIG. 1. In some implementations, the internet client device 230 and the internet destination device 232 are the same computing device or belong to the same network, computing system, and/or entity. In addition, FIG. 2 shows the transparent appliance system 106 having a customer virtual network 210 (e.g., an application VNet), which includes a public load balancer 212 and VM applications 214. The transparent appliance system 106 also includes a provider virtual network 220 having a gateway load balancer 222 and network virtual appliances 224 (or NVAs 224).

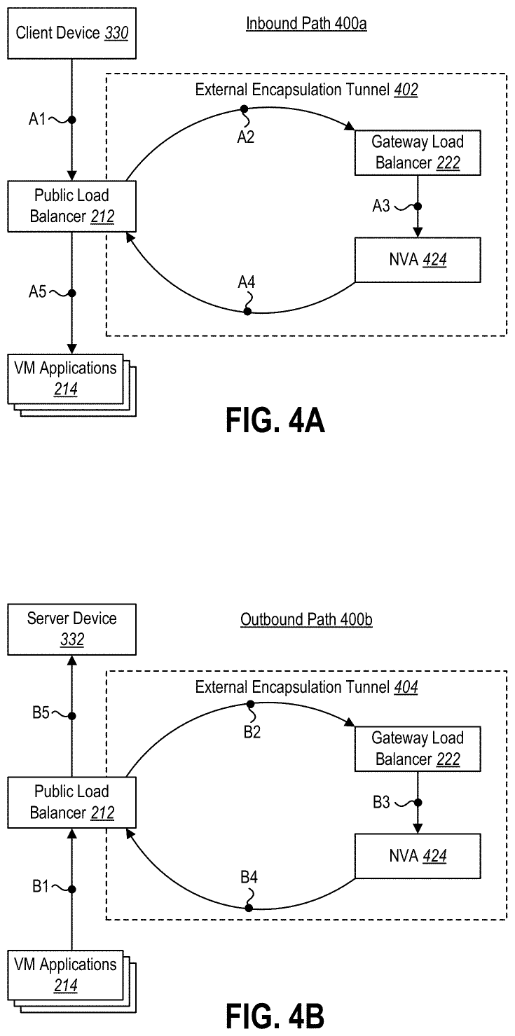

Further, FIG. 2 shows a first set of network data packet flows A1-A6 (e.g., incoming data packets) from the internet client device 230 to the transparent appliance system 106 and a second set of network data packet flows B1-B6 from the transparent appliance system 106 to the internet destination device 232. While an overview of providing incoming data packets to the backend of the customer virtual network 210 is described in FIG. 2, additional detail is provided below in connection with FIG. 4A.

To illustrate, the internet client device 230 provides data packets to the customer virtual network 210, for example, requesting services or information provided by the customer (i.e., customer virtual network 210). As shown by arrow A1, the public load balancer 212 of the customer virtual network 210 receives the incoming data packets. Rather than providing the incoming data packets directly to the VM applications 214, the transparent appliance system 106 intercepts the incoming data packets and provides them to the provider virtual network 220. In particular, the transparent appliance system 106 provides the incoming data packets to a gateway load balancer 222 and NVAs 224 via an external encapsulation tunnel, shown as arrow A2 and arrow A3, respectively. In various implementations, the incoming data packets travel from the public load balancer 212 to the NVAs 224 via an external encapsulation tunnel.

Upon processing the incoming data packets, the transparent appliance system 106 returns the processed incoming data packets to the customer virtual network 210. As shown by arrow A4 and arrow A5, the transparent appliance system 106 returns the processed incoming data packets to the public load balancer 212 via the gateway load balancer 222. The transparent appliance system 106 then provides the processed incoming data packets to the VM applications 214, shown as arrow A6.

In one or more implementations, the customer virtual network 210 provides data packets back to the internet client device 230. In some implementations, the customer virtual network 210 provides data packets to another external device, such as the internet destination device 232. Accordingly, FIG. 2 also includes an overview of the transparent appliance system 106 utilizing the transparently inserted NVAs 224 to process outgoing data packets, shown by the second set of network data packet flows B1-B6. While an overview of provided outgoing data packets to an external device is described here, additional detail is provided below in connection with FIG. 4B.

To illustrate, arrow B1 shows the VM applications 214 sending outgoing data packets to public load balancer 212. The transparent appliance system 106 intercepts the outgoing data packets at the public load balancer 212 and provides them to the gateway load balancer 222, as shown by arrow B2. In addition, as shown by arrow B3, the transparent appliance system 106 provides the outgoing data packets from the gateway load balancer 222 to the NVAs 224 to be processed by one or more of the NVAs 224. In various implementations, the outgoing data packets travel from the public load balancer 212 to the NVAs 224 via an internal encapsulation tunnel.

Upon processing, the outgoing data packets, the transparent appliance system 106 provides the processed outgoing data packets to the public load balancer 212 via the gateway load balancer 222, shown as arrow B4 and arrow B5. In various implementations, the transparent appliance system 106 utilizes the external encapsulation tunnel to provide the processed outgoing data packets to the gateway load balancer 222 and/or public load balancer 212. Then, upon receiving the processed outgoing data packets, the transparent appliance system 106 provides them to the internet destination device 232.

FIG. 3 illustrates an example of a cloud computing system having multiple customer virtual networks operating in connection with a transparently inserted set of network virtual appliances in accordance with one or more implementations. As shown, FIG. 3 includes a client device 330 and a server device 332, which may represent versions of the client devices 130 and the server devices 132 previously introduced. In addition, FIG. 3 includes various components previously introduced, such as the administrator device 134, two versions of the customer virtual network 210 (e.g., customer virtual network A 210a having public load balancer A 212a and VM applications A 214a as well as customer virtual network B 210b having public load balancer B 212b and VM applications B 214b), and the provider virtual network 220 having the gateway load balancer 222 and the NVAs 224.

In one or more implementations, the customer virtual network A 210a and the customer virtual network B 210b are associated with the same customer. In alternative implementations, the customer virtual network A 210a and the customer virtual network B 210b are associated with separate customers. In these implementations, the two customers can utilize the same services of the provider virtual network 220. Additionally, in various implementations, the VM applications A 214a and the VM applications B 214b can be the same or different VM applications.

In some implementations, the provider virtual network 220 is located at or near a customer virtual network. For example, the provider virtual network 220 is located on the same server device, client device, or region as the customer virtual network A 210a. In one or more implementations, the provider virtual network 220 is located apart from a customer virtual network. For instance, the provider virtual network 220 is provided by an entity that is both physically and materially (e.g., commercially) separate from customer virtual network B 210b. In this manner, the provider virtual network 220 can be managed separately from a customer virtual network.

As illustrated, FIG. 3 shows a first set of network data packet flows A1-A6 (e.g., incoming data packets) from the client device 330 and a second set of network data packet flows B1-B6 from the VM applications B 214b to the server device 332. These sets of network data packet flows can correspond to those introduced above in FIG. 2. For example, as shown by arrow A1, the client device 330 sends incoming data packets to the public IP address of customer virtual network A 210a. In various implementations, the customer virtual network A 210a deploys the public load balancer A 212a with a configuration to accept data packets addressed to the public IP address of the customer virtual network A 210a.

In response, the public load balancer A 212a, which is associated with the public IP address, receives the incoming data packets. Rather, than providing the incoming data packets to their destination of the VM applications A 214a, the public load balancer A 212a sends the incoming data packets to a private network address (e.g., a private IP address) of the provider virtual network 220, as shown by arrow A2. For example, the transparent appliance system 106 updates the frontend IP configuration of the public load balancer A 212a to point to the frontend IP configuration if the gateway load balancer 222. In this manner, application traffic going to the public load balancer A 212a seamlessly forwards to the gateway load balancer 222.

In addition, the gateway load balancer 222 at the provider virtual network 220 directs the incoming data packets to the NVAs 224 for processing (e.g., using another private network address), shown as arrow A3, and the provider virtual network 220 receives back processed incoming data packets (e.g., by reversing the source/destination addresses), shown as arrow A4. The gateway load balancer 222 then provides the processed incoming data packets to the public load balancer A 212a. In some implementations, the NVAs 224 provides the processed incoming data packets to the public load balancer A 212a, bypassing the gateway load balancer 222. Finally, the public load balancer A 212a provides the processed incoming data packets to a VM application of the VM applications A 214a, which makes up part of the backend of the customer virtual network A 210a.

In a number of implementations, the provider virtual network 220 receives incoming data packets from multiple customer virtual networks. In these implementations, the provider virtual network 220 (or components thereof) can differentiate the different customer virtual networks by looking into the inner packet of the incoming data packets for a customer identification (e.g., the public IP address of the customer virtual network), based on identifies of their respective encapsulation tunnels, or by using different NICs for each of the customer virtual networks.

Additionally, in various implementations, a VM application or a network virtual appliance can initiate communications with computing devices outside of the transparent appliance system and/or cloud computing system (e.g., external devices). To illustrate, a VM application B of the VM applications B 214b sends outgoing data packets to the server device 332. For example, the VM application addresses the destination of the outgoing data packets as the public IP address of the server device 332. The outgoing data packets first arrive at the public load balancer B 212b, as shown in arrow B1.

Before sending the outgoing data packets on to their destination, the transparent appliance system 106 intercepts the data packets by sending them to the gateway load balancer 222, as shown by arrow B2. As with the incoming data packets, the transparent appliance system 106 utilizes the NVAs 224 of the provider virtual network 220 to process data packets flowing in and out of the associated customer virtual networks. Additionally, as mentioned above, the NVAs 224 can apply different rules and treatments to incoming data packets and outgoing data packets.

As shown by arrow B3, the gateway load balancer 222 provides the outgoing data packets to the NVAs 224, and the processed outgoing data packets are sent back to the gateway load balancer 222, as shown by arrow B4. The gateway load balancer 222 can then return the processed outgoing data packets to the public load balancer B 212b, as shown by arrow B5, treating the processed outgoing data packets as if they arrived from the VM applications B 214b. Indeed, in many implementations, the insertion of the NVAs 224 into the network traffic flow is seamless because the public load balancer B 212b treats the processed outgoing data packets as if they were just forwarding the outgoing data packets from the VM applications B 214b on not processed outgoing data packets from the provider virtual network 220. Further, the public load balancer B 212b transmits the processed outgoing data packets to the public IP address of the server device 332, as shown by arrow B6.

As mentioned above, FIG. 3 includes the administrator device 134. In various implementations, the controls the function of the NVAs 224. For example, the administrator device 134 deploys and removes various NVAs 224 as needed. In addition, the administrator device 134 can provide modifications to the NVAs 224 without modifying the configuration of the public load balancers and/or the backend applications (e.g., the VM applications A 214a and the VM applications B 214b) within a cloud computing system.

Additionally, the administrator device 134 can facilitate transparently inserting the gateway load balancer 222 and the NVAs 224 into a cloud computing system that includes one or more customer virtual networks and a provider virtual network. To elaborate, in one or more implementations, the administrator device 134 deploys the gateway load balancer 222 to the frontend of the provider virtual network 220 having a first private IP address. The administrator device 134 also deploys the NVAs 224 to the backend of the provider virtual network 220 with additional private IP addresses (e.g., virtual IPs). In some implementations, the administrator device 134 provides the first private IP address of the gateway load balancer 114 (e.g., a frontend IP Configuration reference) to the public load balancer (e.g., a customer) to enable the public load balancer to redirect incoming and outgoing data packets to the provider virtual network 220.

Further, the administrator device 134 can configure the health probe rules for the gateway load balancer 222, and in a manner that is independent from the configuration of the public load balancers and the backend applications (i.e., VM applications), which may be configured by one or more customer devices. For instance, the administrator device 134 controls a firewall NVA through a management NIC via a management load balancer (not shown), which can also be a public load balancer having a different public IP than the public load balancers of the customer virtual networks within a cloud computing system.

As mentioned above, FIGS. 4A-4B illustrate examples of network traffic flowing through a cloud computing system having a transparently inserted network virtual appliance in accordance with one or more implementations. As shown, FIGS. 4A-4B include components previously introduced, such as the client device 330, server device 332, public load balancer 212, VM applications 214, and gateway load balancer 222. In addition, FIG. 4A includes an external encapsulation tunnel 402, FIG. 4B includes an internal encapsulation tunnel 404, and both figures include an NVA 424 (i.e., network virtual appliance).

As also mentioned above, FIG. 4A provides additional detail regarding providing incoming data packets to the backend of a customer virtual network. In particular, FIG. 4A illustrates an inbound path 400a of network traffic flowing from the client device 330 to the VM applications 214 via a service chain that includes the NVA 424. In various implementations, the public load balancer 212 and the VM applications 214 are associated with a customer virtual network.

To further illustrate, FIG. 4A includes a first set of network data packet flows A1-A6 (e.g., incoming data packets). For instance, the public load balancer 212 receives incoming data packets from the client device 330, as shown by arrow A1. For example, the client device 330 provides the incoming data packets to the public IP address or other network address of a customer virtual network, which includes the VM applications 214 and the public load balancer 212 tied to the public IP address.

As shown by arrow A2, the public load balancer 212 is chained to the gateway load balancer 222. Accordingly, the transparent appliance system 106 redirects the incoming data packets from the client device 330 to the gateway load balancer 222. In some implementations, the public load balancer 212 is provided a private IP address of the gateway load balancer 222 and instructions to forward incoming data packets to the gateway load balancer 222.

In some instances, the incoming data packets can travel from the public load balancer 212 to the gateway load balancer 222 within the external encapsulation tunnel 402, as shown. For example, the transparent appliance system 106 encapsulates the packet utilizing VXLAN (virtual extensible LAN), Geneve, or another networking tunneling encapsulation protocol. In some implementations, the transparent appliance system 106 can bind the external encapsulation tunnel 402 to component interfaces or process the incoming data packets in a network-aware service.

In one or more implementations, the gateway load balancer 222 inspects the encapsulation incoming data packets and sends the incoming data packets to the NVA 424, as shown by arrow A3. For example, the gateway load balancer 222 determines the NVA 424 from a set of available NVAs, as described above, and sends the encapsulated incoming data packets to the network address (e.g., private IP address) of the NVA 424 via the external encapsulation tunnel 402. The NVA 424 can then un-encapsulate and process the incoming data packets. For instance, in the case the NVA 424 is a firewall application, the NVA 424 handles the encapsulated packet by getting the inner original packet and making the decision to drop or forward the incoming data packets.

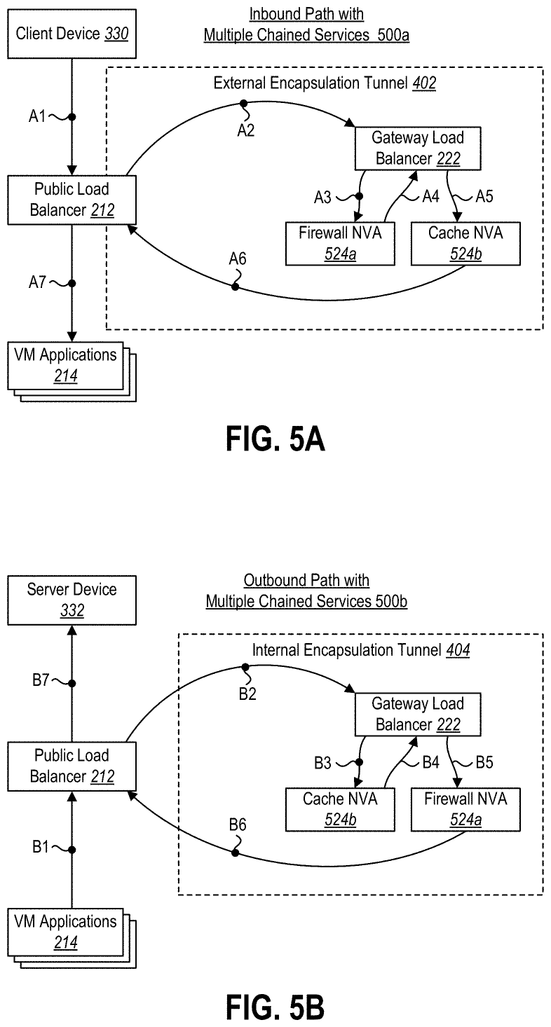

Upon processing the incoming data packets, the NVA 424 sends the processed incoming data packets to the public load balancer 212, as shown by arrow A4. In some implementations, the NVA 424 sends the processed incoming data packets to the public load balancer 212 via the gateway load balancer 222. For example, the gateway load balancer 222 decides the next hop of the processed incoming data packets, which could be the public load balancer 212 or another service (e.g., NVA) on the chain, which is described below in connection with FIG. 5A. In some implementations, the NVA 424 reverses the source/destination addresses or adds a static destination private IP address (e.g., virtual IP) and sends the incoming data packets via the external encapsulation tunnel (e.g., the same encapsulation tunnel) to the gateway load balancer 222 and/or public load balancer 212.

As shown by arrow A5, the public load balancer 212 provides the processed incoming data packets to the VM applications 214 (shown as “VM Apps”). In some instances, the public load balancer 212 provides the incoming data packets to the VM applications 214 without the VM applications 214 detecting that the processed incoming data packets were processed by the NVA 424. For example, in some instances, the incoming data packets that initially arrive at the public load balancer 212 and the processed incoming data packets that later arrive at the public load balancer 212 are identical. In alternative implementations, the processed data packets are modified, but in a manner that is not detected by the public load balancer 212 or the VM applications 214.

In some implementations, the transparent appliance system 106 creates a return path that is the reverse of the inbound path 400a. For example, upon processing one or more requests from the incoming data packets, the VM applications 214 respond to the client device 330 with a set of response data packets. In various implementations, the transparent appliance system 106 generates a return path from the VM applications 214 to the client device 330, where the return path travels back through the public load balancer 212 and the NVA 424 in the reverse order. In these implementations, the transparent appliance system 106 can utilize symmetrical hashing guarantees that the return data packets to the same NVA 424 (e.g., when there are multiple NVAs). In alternative implementations, the return path bypasses the gateway load balancer 222 and/or NVA 424.

In various implementations, the VM applications 214 initiate a set of outgoing data packets. For example, a VM application requests a database or software update and sends out a request to an internet destination device. Other examples include returning a data response or providing proxy traffic. To illustrate, FIG. 4B shows an outbound path 400b of network traffic flowing from the VM applications 214 to the server device 332 via a service chain that includes the NVA 424. In particular, FIG. 4B includes a second set of network data packet flows B1-B6 (e.g., outgoing data packets).

As shown in FIG. 4B, the NVA 424 sends outgoing data packets addressed to the server device 332 (e.g., the public IP address of the server device 332). The public load balancer 212 initially receives the outgoing data packets, as shown by arrow B1. In some implementations, the outgoing data packets undergo a source network address translation (SNAT) to indicate the outgoing virtual or private IP address of the VM application that sent the outgoing data packets and/or translate the private IP address into the public IP address of the public load balancer 212.

As shown by arrow B2, the public load balancer 212 redirects the outgoing data packets to the gateway load balancer 222. In various implementations, the outgoing data packets are provided to the gateway load balancer 222 via an internal encapsulation tunnel 404 (e.g., a VLAN or Geneve tunnel) such that the original outgoing data packets are preserved in the encapsulation tunnel. In some implementations, the inner data packets had a source address that was the SNAT IP address, and in other implementations, the inner data packets had a source address that was the public IP address of the customer virtual network.

FIG. 4B also includes the gateway load balancer 222 sending the outgoing data packets to the NVA 424, as shown by arrow B3. For example, the gateway load balancer 222 sends the incoming data packets to a healthy VM internal interface, such as the NVA 424 or a VM scale set. The NVA 424 then handles the encapsulated outgoing data packets by getting to and processing the inner original packet, as needed.

In addition, the NVA 424 sends the processed outgoing data packets to the public load balancer 212 via the internal encapsulation tunnel 404, shown as arrow B4. For instance, the transparent appliance system 106 reverses the source/destination addresses of the encapsulated outgoing data packets or adds a static destination address (e.g., a virtual IP address). As mentioned above, in some instances, the NVA 424 can differentiate data packets from different customer virtual networks by looking at the inner packet within the external encapsulation tunnel and/or by utilizing different NICs for the different customer virtual networks.

In some implementations, the NVA 424 first sends the processed outgoing data packets to public load balancer 212 via the gateway load balancer 222. For example, the gateway load balancer 222 determines the next hop of the encapsulated outgoing data packets, whether it be the public load balancer 212 or another NVA.

As shown, the public load balancer 212 receives the processed outgoing data packets via the internal encapsulation tunnel 404. In some implementations, the public load balancer 212 un-encapsulates the encapsulated outgoing data packets and directs them toward the server device 332. For example, the public load balancer 212 sends the processed outgoing data packets to the public IP address of the server device 332, as indicated by arrow B5.

In one or more implementations, the transparent appliance system provides a return path through the cloud computing system that is the reverse of the outbound path 400b. For example, upon sending the outgoing data packets to the server device 332, the server device 332 responds with a set of response data packets. In various implementations, the transparent appliance system 106 generates a return path from the public load balancer 212 to the VM applications 214, where the return path travels back through the public load balancer 212 and the NVA 424 in the reverse order of the outbound path 400b. In these implementations, the transparent appliance system 106 can utilize symmetrical hashing guarantees that the return data packets to the same NVA 424 (e.g., when there are multiple NVAs).

As shown in FIGS. 4A and 4B, the transparent appliance system 106 can utilize different encapsulation tunnels for incoming internet traffic (e.g., southbound traffic) and outgoing internet traffic (e.g., northbound traffic). Indeed, the transparent appliance system 106 can employ independent encapsulation tunnels directly into the NVAs allowing for a clear separation of incoming and outgoing traffic. As a result, the transparent appliance system 106 is able to efficiently recognize network traffic that is coming from the internet, and network traffic that is coming from a VM application.

Additionally, by having separate encapsulation tunnels for incoming and outgoing network traffic, the transparent appliance system 106 enables the NVAs to apply different rules, filters, and processes to data packets originating from different sources. Indeed, the same NVA (or set of NVAs) can apply different processes to incoming and outgoing data packets. Further, the same NVA can apply different processes to two incoming data packets from different customer virtual networks.

As mentioned above, the transparent appliance system 106 can chain together multiple network virtual appliances to perform multiple services on incoming or outgoing data packets. As with the NVA 424 shown in FIGS. 4A-4B, the transparent appliance system 106 can transparently insert any number of network virtual appliances into a cloud computing system. To illustrate, FIGS. 5A-5B show examples of network traffic flowing through a cloud computing system having a chain of multiple network virtual appliances in accordance with one or more implementations.

As shown FIGS. 5A-5B include the client device 330, server device 332, public load balancer 212, VM applications 214, gateway load balancer 222, external encapsulation tunnel 402, and internal encapsulation tunnel 404 as introduced above. In addition, FIGS. 5A-5B also include a firewall NVA 524a and a cache NVA 524b, which can represent examples of the NVAs introduced above. While FIGS. 5A-5B illustrate two example NVAs (i.e., network virtual appliances), the transparent appliance system 106 can include any number of NVAs or sets of NVAs. For example, the firewall NVA 524a can represent a set of multiple Firewall NVAs.

FIG. 5A shows an inbound path with multiple chained services 500a and includes a first set of network data packet flows A1-A7 (e.g., incoming data packets) from the client device 330 to the VM applications 214. Arrow Al represents the public load balancer 212 receiving the incoming data packets and arrow A2 represents the gateway load balancer 222 receiving the incoming data packets via the external encapsulation tunnel 402, as described above.

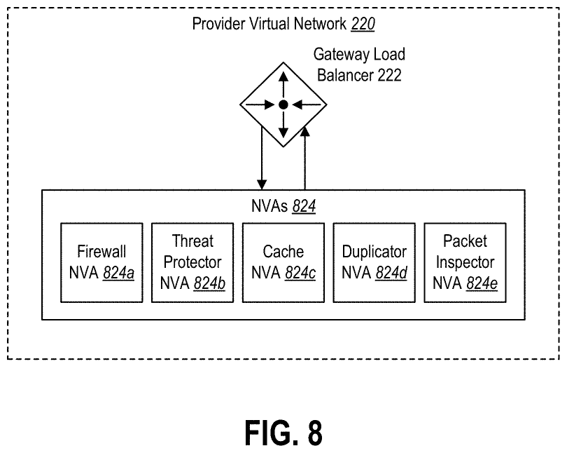

In various implementations, the gateway load balancer 222 may send the incoming data packets to multiple NVAs. For example, as shown by arrow A3, the gateway load balancer 222 determines to send the incoming data packets to the firewall NVA 524a to process the incoming data packets (as further described below in connection with FIG. 8). Upon processing the incoming data packets, the firewall NVA 524a sends them back to the gateway load balancer 222, as shown by arrow A4.

The gateway load balancer 222 then determines to send the incoming data packets to the cache NVA 524b for additional processing (also further described below in connection with FIG. 8). Upon processing the incoming data packets, the cache NVA 524b again sends them to the public load balancer 212, shown as arrow A6. Additionally, the public load balancer 212 transmits the processed incoming data packets to the VM applications 214, as described above.

In various implementations, the firewall NVA 524a sends the processed packets directly to the cache NVA 524b. In some implementations, the cache NVA 524b sends the processed incoming data packets back to the gateway load balancer 222. In these implementations, the gateway load balancer 222 determines where additional processing is needed or whether the cache NVA 524b was the last network virtual appliance. If so, the gateway load balancer 222 forwards the processed incoming data packets to the public load balancer 212 via the external encapsulation tunnel 402, as described above.

In one or more implementations, the gateway load balancer 222 determines an NVA order based on a set of heuristics. For example, for incoming data packets coming from Source A, the gateway load balancer 222 first sends incoming data packets to NVA A, then NVA B; for incoming data packets coming from Source B, the gateway load balancer 222 first sends incoming data packets to NVA B, then NVA A; and for incoming data packets coming from Source C, the gateway load balancer 222 sends incoming data packets only to NVA B. In some implementations, the gateway load balancer 222 determines an NVA order based on rules indicated by an administrator device.

FIG. 5B shows an outbound path with multiple chained services 500b and includes a second set of network data packet flows B1-B7 (e.g., outgoing data packets) from the VM applications 214 to the server device 332. Arrow B1 represents the public load balancer 212 receiving the outgoing data packets and arrow B2 represents the gateway load balancer 222 receiving the outgoing data packets via the internal encapsulation tunnel 404, as described above.

As described above in connection with FIG. 5A, the gateway load balancer 222 may send the incoming data packets to multiple NVAs. However, in some implementations, the transparent appliance system 106 reverses the outbound path with multiple chained services 500b from the inbound path with multiple chained services 500a. To illustrate, FIG. 5B shows the gateway load balancer 222 first determining to send the outgoing data packets to the Cached NVA 524b first, then the firewall NVA 524a. In particular, arrow B4 shows the gateway load balancer 222 sending the outgoing data packets for processing by the cache NVA 524a before they are returned to the gateway load balancer 222, shown as arrow B4. The gateway load balancer 222 then determines to send the outgoing data packets to the firewall NVA 524a, shown as arrow B5.

In addition, the firewall NVA 524a sends the processed outgoing data packets to the public load balancer 212 via the internal encapsulation tunnel 404, shown as arrow B6, which provides them to the server device 332, shown as arrow B7. In some implementations, the firewall NVA 524a sends the processed outgoing data packets back to the gateway load balancer 222, which determines whether to send the processed outgoing data packets to the public load balancer 212 or to another NVA, as described above.

As described above, in many instances, a customer virtual network includes a public load balancer and a set of VM applications. In some instances, however, the customer virtual network does not include a public load balancer and/or includes only a single VM application (or a non-VM application). Indeed, in instances when a customer virtual network includes only a single VM application, the customer virtual network does not need a public load balancer as all incoming data packets go directly to the VM application.

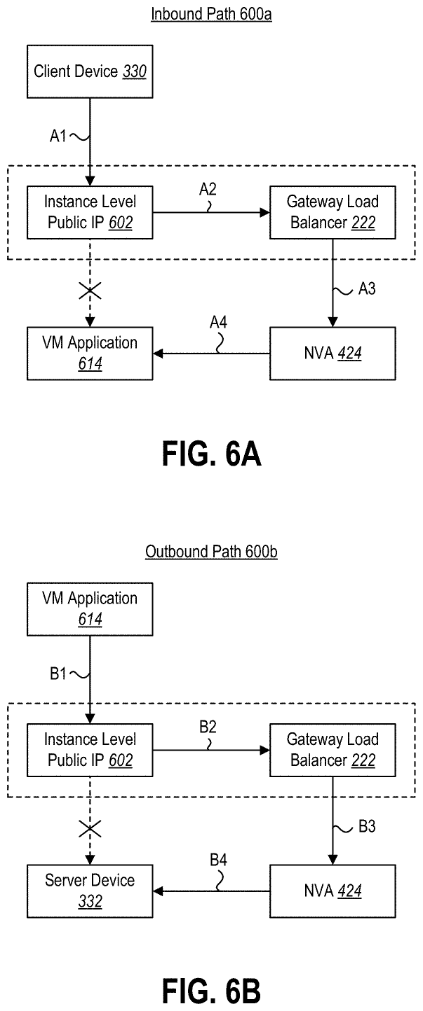

To further illustrate, FIGS. 6A-6B shows examples of network traffic flowing through a cloud computing system having an instance-level public IP and a network virtual appliance in accordance with one or more implementations. As shown, FIGS. 6A-6B include the client device 330, the server device 332, the gateway load balancer 222, and the NVA 424, as described above. In addition, FIGS. 6A-6B include an instance level public IP 602 and a VM application 614. In various implementations, the VM application 614 is an example of one of the VM applications described above,

FIG. 6A shows an inbound path 600a of the client device 330 sending incoming data packets to the VM application 614. In some cases, the client device 330 sends the incoming data packets to the public IP address of a customer virtual network and the instance level public IP 602 is connected to the VM application 614 such that the VM application 614 directly receives the incoming data packets. This is indicated by arrow Al and the cross-out dashed line between the instance level public IP 602 and the VM application 614.

In various implementations, the gateway load balancer 222 is chained to the instance level public IP 602 and receives incoming data packets from outside sources, such as the client device 330. In these implementations, the gateway load balancer 222 can reference the frontend IP configuration of the gateway load balancer 222 with the public IP address of the customer virtual network.

Also, in these implementations, the transparent appliance system 106 can process the incoming data packets at the NVA 424 before providing them to the VM application 614, either directly or via the gateway load balancer 222. Accordingly, as illustrated, the gateway load balancer 222 receives the incoming data packets from the instance level public IP 602 (arrow A2) and provides them to the NVA 424 (arrow A3) for processing the incoming data packets. Then, the NVA 424 provides the processed incoming data packets to the VM application 614 (arrow A4), as described above.

As shown, the transparent appliance system 106 facilitates transparently inserting multiple NVAs into a cloud computing system. In some instances, the transparent appliance system 106 chains the NVAs into a daisy chain or other type of architecture for processing data packets passing through a customer virtual network.

FIG. 6B shows an outbound path 600b of the VM application 614 sending outgoing data packets to the server device 332 (e.g., an external computing device). In some cases, the VM application 614 would send the outgoing data packets directly to the server device 332 (indicated by arrow B1 and the cross-out dashed line between the instance level public IP 602 and the server device 332). In some implementations, the gateway load balancer 222 and the NVA 424 are transparently inserted into the cloud computing system to provide additional services, features, and processing for the outgoing data packets.

Accordingly, as illustrated, the gateway load balancer 222 receives the outgoing data packets from the instance level public IP 602 (arrow B2) and provides them to the NVA 424 (arrow A3) for processing the outgoing data packets. Then, the NVA 424 provides the processed outgoing data packets to the server device 332 (arrow B4), as described above.

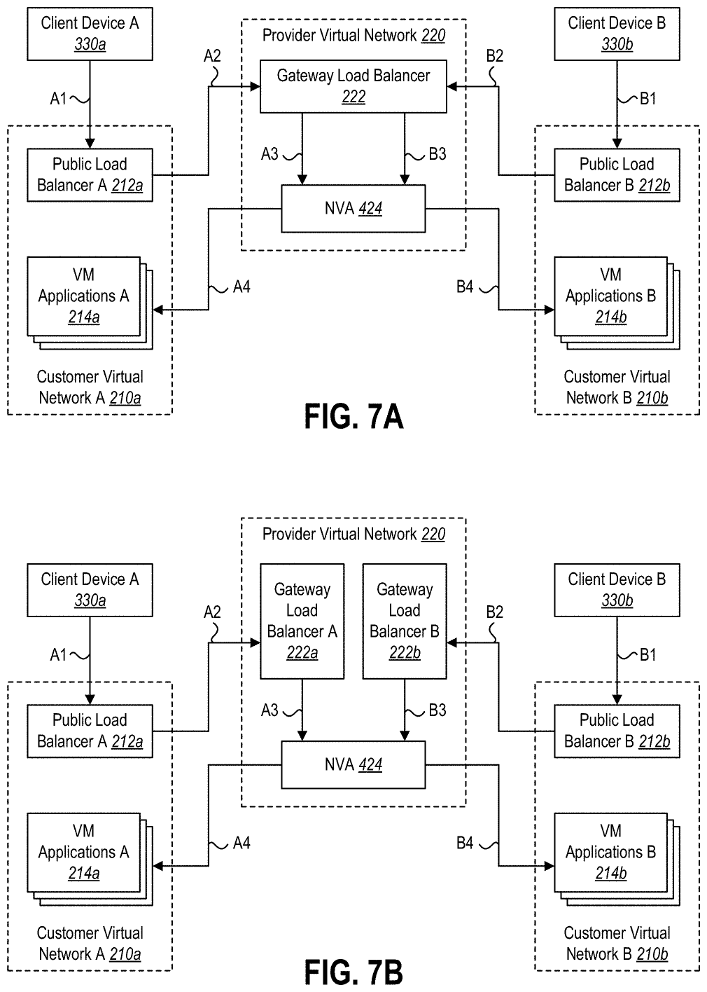

As mentioned above, the transparent appliance system 106 can provide one or more NVAs to multiple customer virtual networks (e.g., share a provider service across multiple consumers). Indeed, multiple customer virtual networks can reference or point to the same gateway load balancer and utilize the same set or sets of NVAs. To illustrate, FIGS. 7A-7B shows examples of network traffic from multiple customer virtual networks flowing through a shared network virtual appliance in accordance with one or more implementations. FIGS. 7A-7B include components introduced previously with the addition of client device 330 being represented by client device A 330a and client device B 330b.

As shown, FIG. 7A includes the customer virtual network A 210a and the customer virtual network B 210b. The public load balancer A 212a of the customer virtual network A 210a points to the gateway load balancer 222 of the provider virtual network 220. Similarly, the public load balancer B 212b of the customer virtual network B 210b also points to the gateway load balancer 222 of the provider virtual network 220. In this manner, the transparent appliance system 106 can utilize the provider virtual network 220 to service both (or more) customer virtual networks. For instance, in one or more implementations, the gateway load balancer 222 is configured with multiple public IP addresses and/or instance-level public IP addresses, even for non-related customer virtual networks.

As provided above, in various implementations, each of the customer virtual networks utilizes a different encapsulation tunnel to provide data packet to and from the provider virtual network 220. In this manner, the transparent appliance system 106 can apply one or more different rules, treatments, or services to each customer virtual network, as described above.

In some implementations, the provider virtual network 220 includes a separate gateway load balancer for each customer virtual network. To illustrate, FIG. 7B shows the provider virtual network 220 including gateway load balancer A 222a associated with the customer virtual network A 210a and gateway load balancer B 222b associated with the customer virtual network B 210b. In these implementations, the transparent appliance system 106 can use the same NVA 424 for the different customer virtual networks, as described above.

Turning now to FIG. 8, this figure illustrates an example of various types of network virtual appliances in accordance with one or more implementations. As noted above, an NVA (i.e., network virtual appliance) can provide a virtual network function or service in a cloud computing system. For example, NVAs can be used for many different kinds of purposes, such as for firewall, distributed denial-of-service (DDoS) protection, packet inspection, application delivery controllers, or another virtual appliance. In various implementations, an NVA can flexibly block, drop, copy, transform, terminate, or initiate connections, as further described below.

As shown, FIG. 8 includes the provider virtual network 220 having the gateway load balancer 222 and NVAs 824. In particular, the NVAs 824 includes different types of NVAs including a firewall NVA 824a, a threat protector NVA 824b, a cache NVA 824c, a duplicator NVA 824d, and a packet inspector NVA 824e. The NVAs 824 can include additional NVAs not shown and each of the NVAs 824 can represent a set of multiple NVAs of the same type.

In one or more implementations, a firewall NVA 824 can process data packets by filtering out unwelcome data packets. To illustrate, a firewall NVA 824a can drop incoming data packets from a client device or outgoing data packets from a VM application. For example, when an incoming data packet is dropped by a firewall NVA 824a, the incoming data packets are not forwarded to the VM application. Rather, the dropped incoming data packets are rejected, discarded, quarantined, and/or otherwise filtered. Otherwise, the firewall NVA 824a can provide approved incoming data packets to the public load balancer and the VM applications of the customer virtual network, as described above.

As mentioned above, because the transparent appliance system 106 utilizes two or more encapsulation tunnels, the transparent appliance system 106 can configure a firewall NVA 824a to perform complex services. For example, a firewall could be used to allow or block traffic sourced from a VM application or the underlying service to the internet (e.g., a server device) as well as separately allowing or blocking traffic from the internet (e.g., a client device) to the VM application.

In some implementations, a threat protector NVA 824b can process data packets by stopping unwelcome data packets. For example, the threat protector NVA 824b can include inline DDoS protection for a customer virtual network and/or a cloud computing system. Indeed, a threat protector NVA 824b can prevent DDoS attacks on customer virtual networks that can cause small or large outages ranging resulting in service disruption.

In various implementations, the cache NVA 824c can process data packets via application acceleration. To elaborate, the cache NVA 824c can be chained in front of a web service to cache responses for a certain amount of time. Using this cached content, the transparent appliance system 106 utilizes the cache NVA 824c in the chain to reduce the load as well as increase the performance of some services. For example, the cache NVA 824c can handle incoming data packet requests coming in from the internet (i.e., client devices) without sending the incoming data packets to a VM application. Additionally, the cache NVA 824c can cache and provide cached data to VM applications sending outgoing data packets which the cache NVA 824c has already cached. By terminating and responding to data packets, the cache NVA 824c can reduce the computational steps and bandwidth of the cloud computing system.

In one or more implementations, the duplicator NVA 824d can process data packets by copying incoming and/or outgoing data packets. For example, the duplicator NVA 824d copies and stores all data packets traveling through the network for legal or compliance purposes. Additionally, in certain implementations, the packet inspector NVA 824e can process data packets by performing a deep packet inspection of incoming and/or outgoing data packets to ensure network security controls and/or compliance requirements.

The above description describes how the transparent appliance system 106 can transparently insert and facilitate NVAs within the network flow of a customer virtual network. In particular, the above description describes transparently adding, removing, and/or changing one or more NVAs to process outgoing and incoming data packets (e.g., north-south traffic paths). In various implementations, the transparent appliance system 106 can likewise transparently insert and facilitate NVAs between two customer virtual networks, referred to as east-west traffic paths.

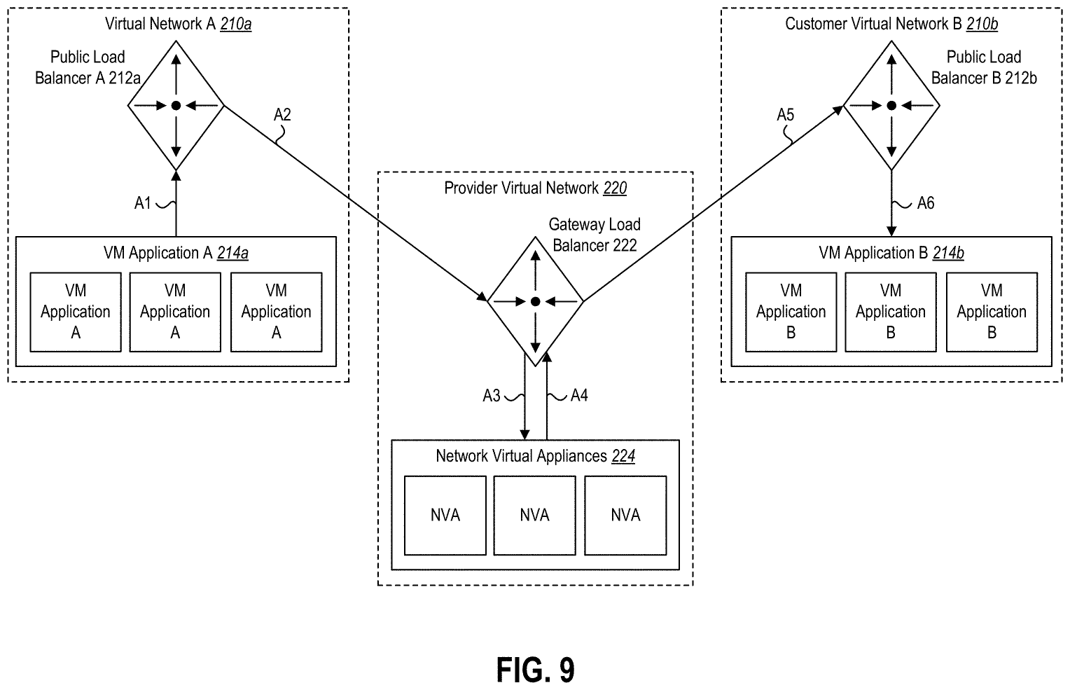

To illustrate, FIG. 9 shows an example of intranet traffic flowing through a cloud computing system having transparently inserted network virtual appliances in accordance with one or more implementations. As shown, FIG. 9 includes components previously introduced, such as the customer virtual network A 210a, the customer virtual network B 210b, and the provider virtual network 220.

As FIG. 9 illustrates, the customer virtual network A 210a sends data packets to the customer virtual network B 210b, where the data packets are processed by the provider virtual network 220 before arriving at the customer virtual network B 210b. In particular, the flow of the data packets is represented by the set of network data packet flows A1-A6.

In various implementations, to insert a service chain having an NVA between customer virtual networks, the transparent appliance system 106 chains the gateway load balancer 222 to a private IP address of one or both of the customer virtual networks. For example, as shown, in FIG. 9, the transparent appliance system 106 configures the gateway load balancer to receive data packets send within the network to the public load balancer B 212b of the customer virtual network B 210b.

Utilizing the transparent appliance system 106 to manage communications between multiple virtual networks of an entity helps prevent security failings from harming the entity. For example, as the entity grows from one customer virtual network to multiple customer virtual networks, one or more of the customer virtual networks may be managed by an application team that does not have a network security background. Here, a customer virtual network could pose a potential risk that could spread between freely connected customer virtual networks of the entity as they could have vulnerabilities that malicious actors can use to launch attacks. Accordingly, to mitigate such risk, the transparent appliance system 106 inserts one or more NVAs as an intrusion prevention system between the customer virtual networks to inspect all east-west traffic

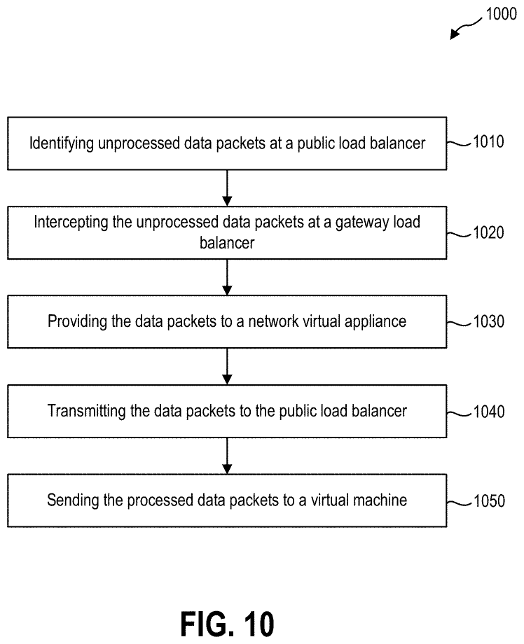

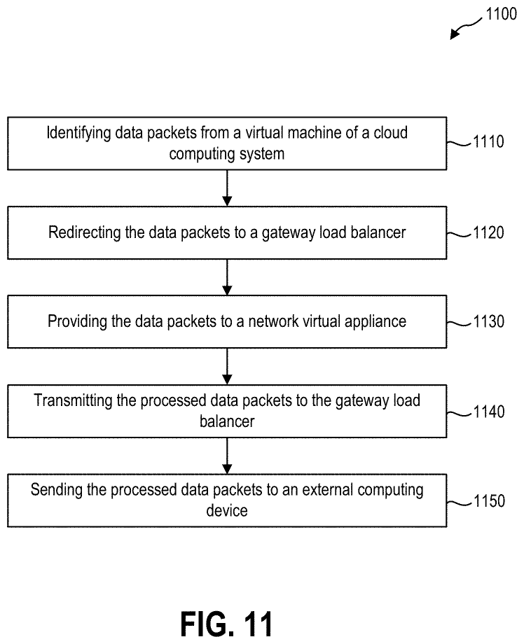

Turning now to FIGS. 10-11, these figures illustrate example flowcharts that each include a series of acts for processing data packets in a cloud computing system utilizing one or more transparently inserted network virtual appliances. While FIGS. 10-11 each illustrates acts according to one or more embodiments, alternative embodiments may omit, add to, reorder, and/or modify any of the acts shown. The acts of FIGS. 10-11 can be performed as part of a method. Alternatively, a non-transitory computer-readable medium can include instructions that, when executed by one or more processors, cause a computing device to perform the acts of FIGS. 10-11. In still further embodiments, a system can perform the acts of FIGS. 10-11.

To illustrate, FIG. 10 shows a series of acts 1000 for processing incoming data packets utilizing a transparently inserted network virtual appliance in accordance with one or more implementations. As shown in FIG. 10, the series of acts 1000 includes an act 1010 of identifying unprocessed data packets at a public load balancer. For instance, the act can 1010 involve identifying unprocessed data packets at a public load balancer that provides data packets to one or more virtual machines of a cloud computing system.

As further shown, the series of acts 1000 includes an act 1020 of intercepting the unprocessed data packets at a gateway load balancer. For instance, the act 1020 can involve intercepting, from the public load balancer, the unprocessed data packets at a gateway load balancer as encapsulated data packets via an external encapsulation tunnel.

In one or more implementations, the act 1020 includes receiving unprocessed data packets via an external encapsulation tunnel as encapsulated data packets at a gateway load balancer from a public load balancer that provides incoming data packets to one or more virtual machines of a cloud computing system. In some implementations, the act 1020 includes providing the unprocessed data packets from the public load balancer to a private network address of the gateway load balancer via the external encapsulation tunnel. In various implementations, the act 1020 includes redirecting sets of unprocessed data packets from a plurality of public load balancers associated with one or more public internet protocol (IP) addresses to the gateway load balancer.

As shown, the series of acts 1000 includes an act 1030 of providing the data packets to a network virtual appliance. For instance, the act can 1030 involve providing the encapsulated data packets from the gateway load balancer to a network virtual appliance to generate processed data packets. In one or more implementations, the act 1030 includes providing the encapsulated data packets from the gateway load balancer to one or more network virtual appliances to generate processed data packets. In some implementations, the act 1030 includes receiving the processed data packets from the network virtual appliance at the gateway load balancer.

In various implementations, the act 1030 includes providing the processed data packets from the gateway load balancer to an additional network virtual appliance for additional processing, wherein the additional network virtual appliance provides different packet processing from the network virtual appliance. In a number of implementations, the act 1030 includes providing data packets from a plurality of gateway load balancers associated with a plurality of cloud computing systems to the one or more network virtual appliances. In some implementations, the network virtual appliances include a firewall, a cache, a duplicator, a threat detector, or a deep packet inspector.

As further shown, the series of acts 1000 includes an act 1040 of transmitting the data packets to the public load balancer. For instance, the act 1040 can involve causing the processed data packets to be transmitted to the public load balancer via the external encapsulation tunnel. In one or more implementations, the act 1040 includes causing the processed data packets to be transmitted to the public load balancer via the external encapsulation tunnel. In some implementations, the act 1040 includes unencapsulating the processed data packets transmitted to the public load balancer to generate unencapsulated processed data packets.

As shown, the series of acts 1000 includes an act 1050 of sending the processed data packets to a virtual machine. For instance, the act can 1050 involve sending the processed data packets from the public load balancer to the one or more virtual machines. In one or more implementations, the act 1050 includes sending the processed data packets unencapsulated from the public load balancer to the one or more virtual machines. In some implementations, the act 1050 includes sending the unencapsulated processed data packets from the public load balancer to the one or more virtual machines without the one or more virtual machines detecting that the processed data packets were processed by the network virtual appliance.

In example implementations, the series of acts 1000 includes additional acts. For example, the series of acts 1000 includes acts of providing an additional set of unprocessed data packets from the gateway load balancer to the network virtual appliance via the external encapsulation tunnel and determining to drop the additional set of unprocessed data packets based on the network virtual appliance processing the additional set of unprocessed data packets. In addition, the series of acts 1000 includes an act of generating an internal encapsulation tunnel for encapsulating sets of data packets between the public load balancer and the gateway load balancer for the sets of data packets initiated at a virtual machine of the one or more virtual machines.

Further, the series of acts 1000 includes an act of reconfiguring the network virtual appliance via an administrator device that is separate from the cloud computing system, where reconfiguring the network virtual appliance does not reconfigure the public load balancer or the one or more virtual machines. The series of acts 1000 also includes an act of combining the public load balancer with the gateway load balancer.

In one or more implementations, the series of acts 1000 includes acts of identifying additional unprocessed data packets at an additional public load balancer of an additional cloud computing system that differs from the cloud computing system, intercepting the additional unprocessed data packets from the additional public load balancer at an additional gateway load balancer, providing the additional unprocessed data packets to the network virtual appliance for processing of the data packets to generate additional processed data packets, causing the additional processed data packets to be transmitted to the additional public load balancer, and sending the additional processed data packets from the additional public load balancer to one or more additional virtual machines of the additional cloud computing system.

Additionally, FIG. 11 shows a series of acts 1100 for transparently inserting network virtual appliances into a networking service chain in accordance with one or more implementations. As shown in FIG. 11, the series of acts 1100 includes an act 1110 of identifying data packets from a virtual machine of a cloud computing system. For instance, the act can 1110 involve identifying data packets at a public load balancer from a virtual machine of a cloud computing system to be sent to an external computing device that is external to the cloud computing system.

As further shown, the series of acts 1100 includes an act 1120 of redirecting the data packets to a gateway load balancer. For instance, the act can 1120 involve redirecting the data packets as encapsulated data packets from the public load balancer to a gateway load balancer via an internal encapsulation tunnel.

As shown, the series of acts 1100 includes an act 1130 of providing the data packets to a network virtual appliance. For instance, the act can 1130 involve providing the encapsulated data packets from the gateway load balancer to a network virtual appliance to generate processed data packets. In one or more implementations, the act 1130 includes receiving the processed data packets from the network virtual appliance at the gateway load balancer and providing the processed data packets to an additional network virtual appliance for additional processing, wherein the additional network virtual appliance provides different packet processing from the network virtual appliance.

As further shown, the series of acts 1100 includes an act 1140 of transmitting the processed data packets to the gateway load balancer. For instance, the act 1140 can involve causing the processed data packets to be transmitted to the gateway load balancer via the internal encapsulation tunnel. In one or more implementations, the act 1140 includes causing the processed data packets to be transmitted to the gateway load balancer via the internal encapsulation tunnel.

As shown, the series of acts 1100 includes an act 1150 of sending the processed data packets to an external computing device. For instance, the act can 1150 involve sending the processed data packets from the public load balancer to the one or more virtual machines. In one or more implementations, the act 1150 includes sending the processed data packets from the gateway load balancer to the external computing device.

In one or more implementations, the series of acts 1100 includes additional acts. For example, the series of acts 1100 includes acts of identifying an additional set of data packets at the public load balancer from the virtual machine to be sent to the external computing device, providing the additional set of data packets from the gateway load balancer that intercepts the additional set of data packets to the network virtual appliance, retrieving requested content from a local storage device based on the network virtual appliance processing the additional set of data packets, and returning the requested content to the virtual machine without sending the processed data packets to the external computing device.

In some implementations, the series of acts 1100 includes an act of generating an external encapsulation tunnel for encapsulating sets of data packets between the public load balancer and the gateway load balancer for the sets of data packets received at the public load balancer from computing devices that are external to the cloud computing system. In various implementations, the series of acts 1100 includes an act of removing the gateway load balancer from intercepting sets of data packets without disrupting data packet traffic flow between the public load balancer and the virtual machine.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links that can be used to carry needed program code means in the form of computer-executable instructions or data structures and which can be accessed by a general-purpose or special-purpose computer. Combinations of the above should also be included within the scope of computer-readable media.

In addition, the network described herein may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which one or more computing devices may access the transparent appliance system 106. Indeed, the networks described herein may include one or multiple networks that use one or more communication platforms or technologies for transmitting data. For example, a network may include the Internet or other data link that enables transporting electronic data between respective client devices and components (e.g., server devices and/or virtual machines thereon) of the cloud computing system.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (NIC), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special-purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

FIG. 12 illustrates certain components that may be included within a computer system 1200. The computer system 1200 may be used to implement the various devices, components, and systems described herein.

In various implementations, the computer system 1200 may represent one or more of the client devices, server devices, or other computing devices described above. For example, the computer system 1200 may refer to various types of client devices capable of accessing data on a cloud computing system. For instance, a client device may refer to a mobile device such as a mobile telephone, a smartphone, a personal digital assistant (PDA), a tablet, a laptop, or a wearable computing device (e.g., a headset or smartwatch). A client device may also refer to a non-mobile device such as a desktop computer, a server node (e.g., from another cloud computing system), or another non-portable device.

The computer system 1200 includes a processor 1201. The processor 1201 may be a general-purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 1201 may be referred to as a central processing unit (CPU). Although just a single processor 1201 is shown in the computer system 1200 of FIG. 12, in an alternative configuration, a combination of processors (e.g., an ARM and DSP) could be used.

The computer system 1200 also includes memory 1203 in electronic communication with the processor 1201. The memory 1203 may be any electronic component capable of storing electronic information. For example, the memory 1203 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 1205 and data 1207 may be stored in the memory 1203. The instructions 1205 may be executable by the processor 1201 to implement some or all of the functionality disclosed herein. Executing the instructions 1205 may involve the use of the data 1207 that is stored in the memory 1203. Any of the various examples of modules and components described herein may be implemented, partially or wholly, as instructions 1205 stored in memory 1203 and executed by the processor 1201. Any of the various examples of data described herein may be among the data 1207 that is stored in memory 1203 and used during execution of the instructions 1205 by the processor 1201.

A computer system 1200 may also include one or more communication interfaces 1209 for communicating with other electronic devices. The communication interface(s) 1209 may be based on wired communication technology, wireless communication technology, or both. Some examples of communication interfaces 1209 include a Universal Serial Bus (USB), an Ethernet adapter, a wireless adapter that operates in accordance with an Institute of Electrical and Electronics Engineers (IEEE) 1202.11 wireless communication protocol, a Bluetooth® wireless communication adapter, and an infrared (IR) communication port.

A computer system 1200 may also include one or more input devices 1211 and one or more output devices 1213. Some examples of input devices 1211 include a keyboard, mouse, microphone, remote control device, button, joystick, trackball, touchpad, and light pen. Some examples of output devices 1213 include a speaker and a printer. One specific type of output device that is typically included in a computer system 1200 is a display device 1215. Display devices 1215 used with embodiments disclosed herein may utilize any suitable image projection technology, such as liquid crystal display (LCD), light-emitting diode (LED), gas plasma, electroluminescence, or the like. A display controller 1217 may also be provided, for converting data 1207 stored in the memory 1203 into text, graphics, and/or moving images (as appropriate) shown on the display device 1215.

The various components of the computer system 1200 may be coupled together by one or more buses, which may include a power bus, a control signal bus, a status signal bus, a data bus, etc. For the sake of clarity, the various buses are illustrated in FIG. 12 as a bus system 1219.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The techniques described herein may be implemented in hardware, software, firmware, or any combination thereof unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

Computer-readable media can be any available media that can be accessed by a general-purpose or special-purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

As used herein, non-transitory computer-readable storage media (devices) may include RAM, ROM, EEPROM, CD-ROM, solid-state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general-purpose or special-purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, or another data structure), ascertaining and the like. Also, “determining” can include receiving (e.g., receiving information), accessing (e.g., accessing data in a memory), and the like. Also, “determining” can include resolving, selecting, choosing, establishing, and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A computer-implemented method for transparently inserting network virtual appliances into a networking service chain comprising:
identifying unprocessed data packets at a public load balancer that provides data packets to one or more virtual machines of a cloud computing system;
intercepting, from the public load balancer, the unprocessed data packets at a gateway load balancer as encapsulated data packets via an external encapsulation tunnel;
providing the encapsulated data packets from the gateway load balancer to a network virtual appliance to generate processed data packets;
causing the processed data packets to be transmitted to the public load balancer via the external encapsulation tunnel; and
sending the processed data packets from the public load balancer to the one or more virtual machines.

2. The computer-implemented method of claim 1, further comprising:
unencapsulating the processed data packets transmitted to the public load balancer to generate unencapsulated processed data packets,
wherein sending the processed data packets from the public load balancer to the one or more virtual machines comprises sending the unencapsulated processed data packets from the public load balancer to the one or more virtual machines without the one or more virtual machines detecting that the processed data packets were processed by the network virtual appliance.

3. The computer-implemented method of claim 1, wherein intercepting the unprocessed data packets comprises providing the unprocessed data packets from the public load balancer to a private network address of the gateway load balancer via the external encapsulation tunnel.

4. The computer-implemented method of claim 1, further comprising:
providing an additional set of unprocessed data packets from the gateway load balancer to the network virtual appliance via the external encapsulation tunnel; and
determining to drop the additional set of unprocessed data packets based on the network virtual appliance processing the additional set of unprocessed data packets.

5. The computer-implemented method of claim 1, further comprising:
receiving the processed data packets from the network virtual appliance at the gateway load balancer; and
providing the processed data packets from the gateway load balancer to an additional network virtual appliance for additional processing, wherein the additional network virtual appliance provides different packet processing from the network virtual appliance.

6. The computer-implemented method of claim 1, further comprising generating an internal encapsulation tunnel for encapsulating sets of data packets between the public load balancer and the gateway load balancer for the sets of data packets initiated at a virtual machine of the one or more virtual machines.

7. The computer-implemented method of claim 1, wherein intercepting the unprocessed data packets comprises redirecting sets of unprocessed data packets from a plurality of public load balancers associated with one or more public IP addresses to the gateway load balancer.

8. The computer-implemented method of claim 1, further comprising:
identifying additional unprocessed data packets at an additional public load balancer of an additional cloud computing system that differs from the cloud computing system;
intercepting the additional unprocessed data packets from the additional public load balancer at an additional gateway load balancer;
providing the additional unprocessed data packets to the network virtual appliance for processing of the data packets to generate additional processed data packets;
causing the additional processed data packets to be transmitted to the additional public load balancer; and
sending the additional processed data packets from the additional public load balancer to one or more additional virtual machines of the additional cloud computing system.

9. The computer-implemented method of claim 1, further comprising reconfiguring the network virtual appliance via an administrator device that is separate from the cloud computing system, wherein reconfiguring the network virtual appliance does not reconfigure the public load balancer and the one or more virtual machines.

10. The computer-implemented method of claim 1, wherein the public load balancer and the gateway load balancer are implemented within a single network device.

11. A computer-implemented method for transparently inserting network virtual appliances into a networking service chain comprising:
identifying data packets at a public load balancer from a virtual machine of a cloud computing system to be sent to an external computing device that is external to the cloud computing system;
redirecting the data packets as encapsulated data packets from the public load balancer to a gateway load balancer via an internal encapsulation tunnel;
providing the encapsulated data packets from the gateway load balancer to a network virtual appliance to generate processed data packets;
causing the processed data packets to be transmitted to the gateway load balancer via the internal encapsulation tunnel; and
sending the processed data packets from the gateway load balancer to the external computing device.

12. The computer-implemented method of claim 11, further comprising:
identifying an additional set of data packets at the public load balancer from the virtual machine to be sent to the external computing device;
providing the additional set of data packets from the gateway load balancer that intercepts the additional set of data packets to the network virtual appliance;
retrieving requested content from a local storage device based on the network virtual appliance processing the additional set of data packets; and
returning the requested content to the virtual machine without sending the processed data packets to the external computing device.

13. The computer-implemented method of claim 11, further comprising:
receiving the processed data packets from the network virtual appliance at the gateway load balancer; and
providing the processed data packets to an additional network virtual appliance for additional processing, wherein the additional network virtual appliance provides different packet processing from the network virtual appliance.

14. The computer-implemented method of claim 11, wherein sending the processed data packets comprises sending the processed data packets from the gateway load balancer via the public load balancer.

15. The computer-implemented method of claim 11, further comprising generating an external encapsulation tunnel for encapsulating sets of data packets between the public load balancer and the gateway load balancer for the sets of data packets received at the public load balancer from computing devices that are external to the cloud computing system.

16. The computer-implemented method of claim 11, further comprising removing the gateway load balancer from intercepting sets of data packets without disrupting data packet traffic flow between the public load balancer and the virtual machine.

17. A system comprising:
at least one processor; and
a non-transitory computer memory comprising instructions that, when executed by the at least one processor, cause the system to:
receive unprocessed data packets via an external encapsulation tunnel as encapsulated data packets at a gateway load balancer from a public load balancer that provides incoming data packets to one or more virtual machines of a cloud computing system;
provide the encapsulated data packets from the gateway load balancer to one or more network virtual appliances to generate processed data packets;
cause the processed data packets to be transmitted to the public load balancer via the external encapsulation tunnel; and
send the processed data packets unencapsulated from the public load balancer to the one or more virtual machines.

18. The system of claim 17, wherein the one or more network virtual appliances comprise a firewall, a cache, a packet duplicator, a threat detector, or a deep packet inspector.

19. The system of claim 17, further comprising additional instructions that, when executed by the at least one processor, cause the system to redirect sets of data packets from a plurality of public load balancers associated with one or more public internet protocol (IP) addresses to the gateway load balancer.

20. The system of claim 17, further comprising additional instructions that, when executed by the at least one processor, cause the system to provide data packets from a plurality of gateway load balancers associated with a plurality of cloud computing systems to the one or more network virtual appliances.
